(19) United States
(12) Patent Application Publication
(10) Pub. No.: US 2012/0301257 A1
(43) Pub. Date: Nov. 29, 2012

(54) Excavator Thumb

(75) Inventor: Gregory A. Seljestad, Wamego, KS (US)

(73) Assignee: CATERPILLAR, INC., Peoria, IL (US)

(21) Appl. No.: 13/116,185

(22) Filed: May 26, 2011

(51) Int. Cl. E02F 3/413; B66C 1/42

(52) U.S. Cl. 414/722; 414/729

(57) ABSTRACT

A thumb and linkage assembly for covering the bucket of an excavator is shown and described. The thumb and linkage assembly includes a bracket coupled to a lift arm of an excavator or prime mover. The assembly also includes a base link and a thumb link. The base link has a proximal portion pivotally coupled to the bracket. The base link also has a distal portion pivotally coupled to a proximal portion of the thumb link. The thumb link has a distal portion pivotally coupled to at least one thumb of a plurality of thumbs. The plurality of thumbs are coupled together and pivotally coupled to the bracket. The bracket includes a first lock hole for locking the assembly in a stored position. At least one of the proximal portion of the thumb link, the distal portion of the base link or one of the thumbs include a second lock hole that is in axial alignment with the first lock hole when the assembly is in the stored position. The assembly also includes a removable pin that is received in the first and second lock holes for locking the assembly in the stored position.

### TECHNICAL FIELD

This disclosure generally relates to the linkages used to control the position of a thumb assembly used with a bucket on a prime mover such as an excavator. More particularly, the linkage allows the thumb assembly to be moved more easily and may avoid the thumb assembly swinging freely between positions or between the removal and replacement of a locking pin.

### BACKGROUND

An excavator is a machine that generally includes a boom that supports an extendable lift arm, also known in the trade as a “dipper arm,” a “dipper stick,” or a “stick” onto which is attached an excavator tool—such as an excavator bucket or rake. The excavator tool is typically attached to the distal portion of the lift arm with a pin. A piston cylinder assembly operating through a tool linkage assembly is used to control the excavator tool.

An excavator thumb assembly or “thumb” may be used in combination with any of a variety of excavator tools, especially buckets. A pin on certain types of excavator thumbs may be connected to the distal portion of the lift arm. Many excavator thumbs are not hydraulically powered and, as a result, must be moved from an operating position to a stored position by removing a pin from a strut that holds the thumb in place over the bucket before moving the strut in a proximal direction away from the bucket and along a bracket mounted to the lift arm. The bracket will typically include a proximal locking hole that can be used with the pin to lock the thumb in place against the bracket and lift arm as illustrated in U.S. Pat. No. 6,203,267 and FIG. 3 of the present application.

One problem associated with current excavator thumb assemblies is that once the pin is removed, the strut and thumb can swing freely. This is problematic as a typical excavator thumb assembly can exceed 600 pounds while the strut can exceed 100 pounds. Because the pin must be frictionally received in the locking hole or a pair of aligned locking holes provided by some bracket designs, both skill and experience are usually required to safely lock the thumb assembly in the stored position or to lock the thumb assembly in any of the operating positions.

As one will note from U.S. Pat. No. 6,203,267, the bracket that is pivotally connected to the lift arm also provides a pivotal connection for the strut and the bracket includes a plurality of spaced apart holes through which the pin may be inserted to hold the thumb assembly at varying operating positions. While providing a variety of operating positions is beneficial, removing the pin from one hole and moving the strut and pin to another selected hole for purposes of changing the position of the excavator thumb can be difficult. Specifically, the strut of the '267 patent is T-shaped at one end and is received in a complementary slot in the bracket. The possibility of binding between the pin and the holes in the bracket or between the T-shaped end of the strut and the slot in the bracket is significant because of debris, corrosion, lack of lubrication, etc. While the strut and thumb of the '267 patent do not swing freely after the pin is removed, many designs allow the strut and thumb assembly to swing freely after the pin is removed, thereby presenting a safety hazard.

Thus, improved excavator thumb assemblies are needed that are easier and safer to use.

### SUMMARY OF THE DISCLOSURE

A thumb and linkage assembly for an excavator having a lift arm is disclosed. The thumb and linkage assembly include a bracket coupled to a lift arm of the excavator. The assembly also includes a base link and a thumb link. The base link has a proximal portion pivotally coupled to the bracket. The base link also has a distal portion pivotally coupled to a proximal portion of the thumb link. The thumb link has a distal portion pivotally coupled to at least one thumb of a plurality of thumbs. The plurality of thumbs is coupled together and pivotally coupled to the bracket. The bracket includes a first lock hole for locking the assembly in a stored position. At least one of the proximal portion of the thumb link, the distal portion of the base link or one of the thumbs includes a second lock hole that is in axial alignment with the first lock hole when the assembly is in the stored position. Finally, the assembly also includes a removable pin that is received in the first and second lock holes for locking the assembly in the stored position.

An excavator is also disclosed that includes a lift arm pivotally connected to a bucket and a thumb and linkage assembly pivotally connected to the lift arm. The thumb and linkage assembly includes an elongated bracket that has a proximal portion and a distal portion. The elongated bracket is coupled to the lift arm and the elongated bracket includes an elongated base disposed between at least one pair of walls. Each wall includes at least one hole that is axially aligned with a hole in the other wall to provide a first pair of axially aligned holes. The assembly also includes a pair of base links and a pair of thumb links. The base links each include a proximal portion pivotally coupled to the bracket at the first pair of axially aligned holes. The base links also each have a distal portion pivotally coupled to a proximal portion of one of the thumb links. The thumb links each have a distal portion pivotally connected to at least one thumb of a plurality of spaced-apart thumbs. The plurality of thumbs are coupled together and pivotally coupled to the distal portion of the bracket. The proximal portion of the bracket includes a first lock hole for locking the assembly in a stored position. At least one of the proximal portions of the thumb links, the distal portions of the base links, or one of the thumbs may include a second lock hole that is in axial alignment with the first lock hole when the assembly is in the stored position. The assembly further includes a removable pin that is received in the first and second lock holes for locking the assembly in the stored position.

A method for securing a thumb and linkage assembly in a stored position against a lift arm of an excavator is also disclosed. The method includes providing a thumb and linkage assembly that includes a bracket coupled to a lift arm, a base link and a thumb link. The base link has a proximal portion pivotally coupled to the bracket and a distal portion pivotally coupled to a proximal portion of the thumb link. The distal portion of the base link and the proximal portion of the thumb link also include an additional hole for receiving a removable pin when the base and thumb links are in alignment with each other. The thumb link has a distal portion pivotally coupled to at least one thumb of a plurality of thumbs. The plurality of thumbs are coupled together and pivotally coupled to the bracket. The bracket includes a first lock hole for locking the assembly in a stored position. At least one of the proximal portion of the thumb link, the distal portion of the thumb link or one of the thumbs includes a second lock hole that is in axial alignment with the first lock hole when the assembly is in the stored position. The removable pin may be received in the first and second lock holes for locking the assembly in the stored position. The method further includes removing the pin from the additional holes of the thumb and base links, folding the thumbs back towards the bracket and lift arm and inserting the removable pin through the first and second lock holes.

### BRIEF DESCRIPTION OF THE DRAWINGS

FIG. 1 is a side view of a prior art prime mover or excavator with a boom, lift arm and bucket.

FIG. 2 is a partial elevational view of a prior art lift arm, bucket and thumb assembly wherein the thumb assembly is in a closed or clamping position.

FIG. 3 is a view similar to that shown in FIG. 1 illustrating the thumb assembly in the open or stored position which is achieved by detaching the strut from one end of the bracket and reattaching the strut at an opposite end of the bracket as seen when comparing FIGS. 2 and 3.

FIGS. 4-10 illustrate a disclosed thumb and linkage assembly and further illustrate the procedure for moving the disclosed thumb and linkage assembly from a clamping or working position shown in FIG. 4 to a stored position shown in FIG. 10.

FIGS. 11-18 sequentially illustrate a method for changing the pivot point between the thumb links and base links (FIGS. 11-12) and unlocking the thumb and linkage assembly from the stored position shown in FIG. 10 (FIG. 13 and moving up the assembly to the locked and open or working position shown in FIG. 18.

### DETAILED DESCRIPTION

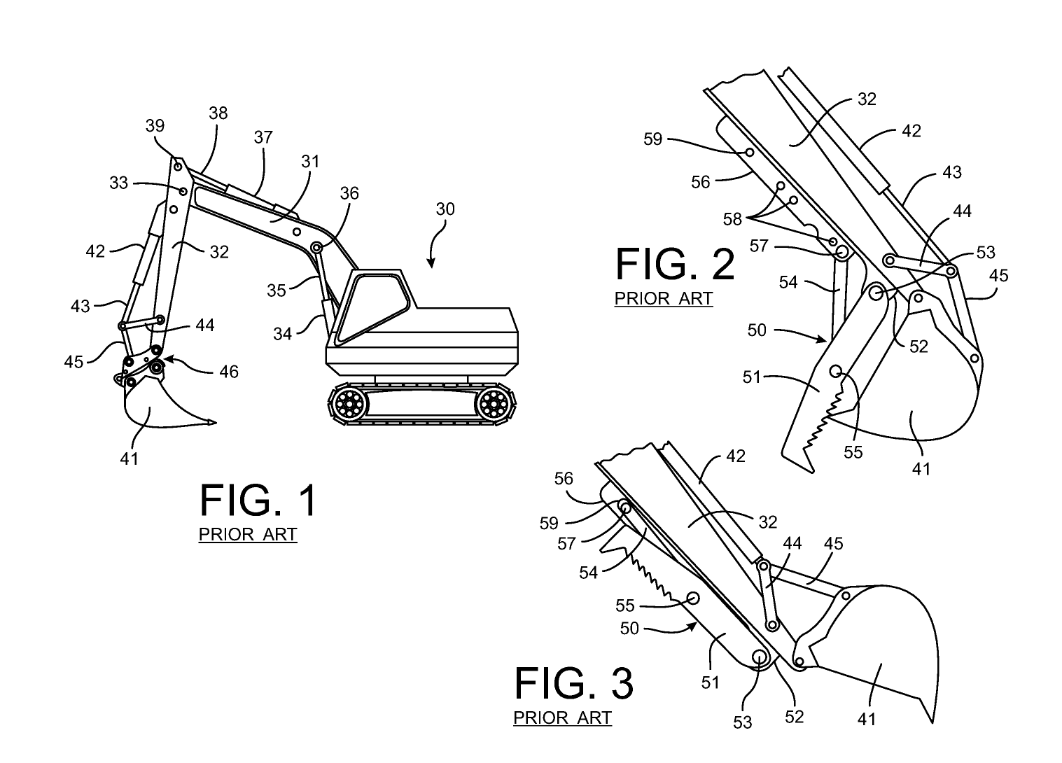

For purposes of providing a background environment in which the disclosed thumb and linkage assembly may be used, FIG. 1 depicts an exemplary prime mover or, in this case, excavator 30 that includes an articulating boom 31. The boom 31 is pivotally connected to a lift arm 32 by a pin 33. Movement of the boom 31 may be actuated by the cylinder 34 and piston 35, which are controlled by the hydraulics of the excavator 30 and which will not be addressed in detail here. The piston 35 is connected to the boom 31 by the pin 36. Control of the lift arm 32 is provided by the cylinder 37 and piston 38. The piston 38 is connected to the lift arm 32 by the pin 39. Control of the bucket 41 is provided by the cylinder 42 and piston 43. The piston 43 is coupled to an anchor link 44 and an articulating link 45, which connects the cylinder 42 and piston 43 to the coupler assembly shown generally at 46.

A thumb assembly 50, the bucket 41 and a portion of the lift arm 32 are illustrated in FIGS. 2-3. The thumb assembly 50 will typically include a plurality of thumbs 51 connected together in parallel and pivotally connected to a bracket 52 by a pin 53. The thumb 51 is also connected to a strut 54. The strut 54 is pivotally coupled to the thumb 51 at its distal end by the pin 55 and is connected to the bracket 56 (which may be part of the bracket 52) at its proximal end by the pin 57. The bracket 56 includes a plurality of holes 58 which may be used to adjust the position of the proximal end of the strut 54 as the pin 57 will be received in any of the holes 58. The hole shown in 59 is used for locking the thumb assembly 50 in place. Specifically, the pin 57 must be removed and the strut 54 decoupled from the bracket 56. The strut 54 must then be moved so its proximal end is in axial alignment with the locking hole 59. However, once the pin 57 is removed, the thumb assembly 50 can swing freely thereby requiring the operator or operators to exercise care and to select a position for the lift arm 32 or a performing the storage operation illustrated in FIGS. 2-3.

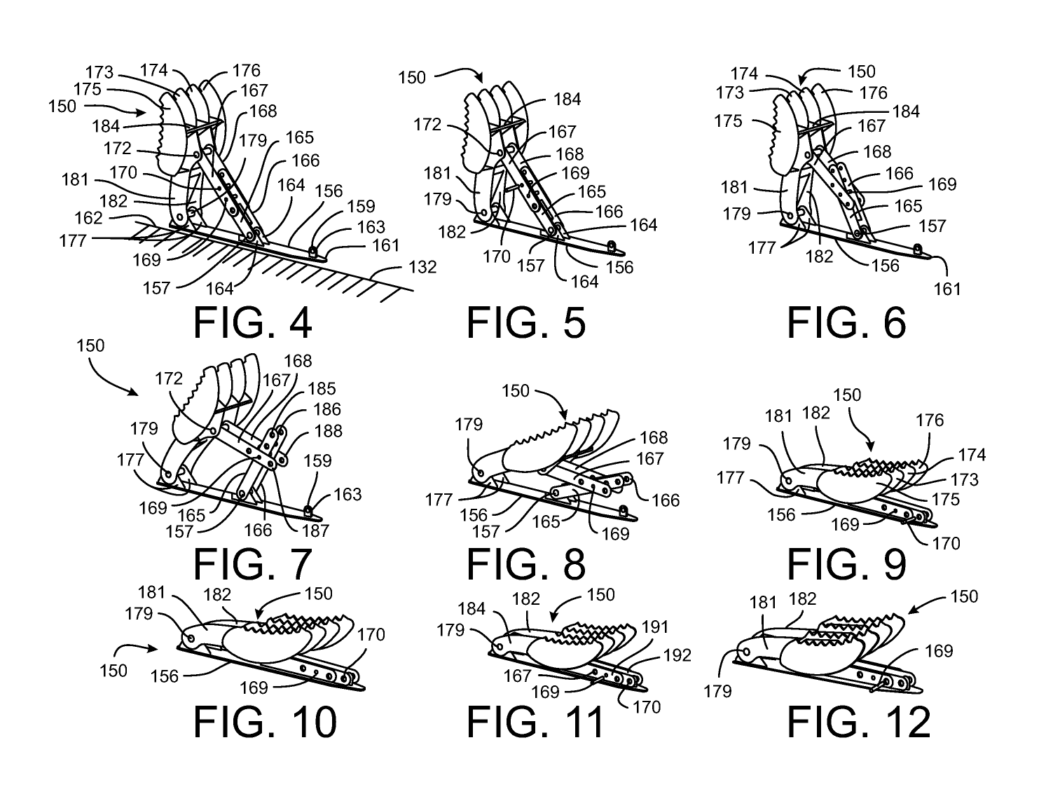

Returning first to FIG. 4, a lift arm is shown schematically at 132. The disclosed thumb and linkage assembly 150 includes a bracket 156 mounted on the lift arm 132. The bracket 156 includes a proximal end 161 and a distal end 162. The proximal end 161 of the bracket 156 includes an upwardly extending tab 163 with a lock hole 159 disposed therein. The bracket 156 also includes a pair of upwardly protruding walls 164, both of which are pivotally connected to base links 165, 166. Specifically, proximal ends of the base links 165, 166 are connected to the walls 164 by pins, one of which is shown at 157. The base links 165, 166 are, in turn, connected to a pair of thumb links 167, 168.

The thumb links 167, 168 are pivotally coupled to the base links 165, 166 by the removable pins 169, 170. While the removable pins 169, 170 pivotally couple the base links 165, 166 to the thumb links 167, 168 respectively, the removable pin 170, in combination with the removable pin 169 locks the base link 165 and thumb link 167 into a straight orientation and, similarly, locks the base link 166 to the thumb link 168 in a straight orientation as shown in FIGS. 4-5. FIG. 4 also illustrates the pivot pin 172 that pivotally connects the distal ends of the thumb links 167, 168 to the middle thumbs 173, 174 of the four thumb assembly that also includes outer thumbs 175, 176. The middle thumbs 173, 174 may include extensions in the form of legs 181, 182 that may be coupled to the bracket 156 at the upwardly extending walls 177 by the pivot pin 179. Finally, the thumbs 173-176 may be connected by one or more cross beams shown at 184.

In FIG. 4, the thumb and linkage assembly 150 is in a closed or working position. The removable pin 170, in combination with the removable pin 169 converts the thumb links 167, 168 and base links 165, 166 into a pair of rigid struts. To move the thumb and linkage assembly 150 from the working position shown in FIG. 4 to the stored position of FIG. 10, the operator may first remove the removable pin 170 as shown in FIG. 5. This enables the thumb links 167, 168 to pivot with respect to the base links 165, 166 as illustrated in FIGS. 6-9. Even though the thumb and linkage assembly 150 may be folded backwards in the orientation of FIGS. 4-10, the thumb and linkage assembly 150 is still connected to the bracket 156 by the removable pin 169, the pivot pin 172 and the pivot pin 179. Thus, while the thumb and linkage assembly 150 is foldable with the pin 170 removed, it cannot swing freely like the thumb assemblies shown in the prior art.

After the removable pin 170 is removed (FIG. 5), the thumbs 173-176 are folded backwards or towards the right in the orientation of FIGS. 1-10 and eventually downward towards the tab 163 and lock hole 159. When the position shown in FIGS. 9 and 10 has been reached, the removable pin 170 may be inserted through the lock hole 159 and through one or more holes including the holes 185, 186 disposed at the distal ends of the base links 165, 166 or the holes 187, 188 disposed at the proximal ends of the thumb links 167, 168. In the embodiment illustrated in FIGS. 1-18, the holes 185, 186 disposed at the distal ends of the base links 165, 166 are used to receive the removable pin 170 as shown in FIGS. 9-10.

Returning to FIG. 11, to change the working position of the thumb and linkage assembly 150 from the relatively upright position shown in FIG. 4 to the slanted position shown in FIG. 18, the coupling between the base links 165, 166 and the thumb links 167, 168 may be altered. Specifically, returning to FIG. 11, with the removable pin 170 remaining in place, the removable pin 169 is removed from the hole shown at 191 in the thumb link 167 to the hole 192 in the thumb link 167. Of course, corresponding coaxial holes also exist in the other links 165, 166, 168. By changing the position of the removable pin 169 from the more distal hole 191 to the more proximal hole 192, the overall length of each base link/thumb link pair 165, 167 and 166, 168 is lengthened thereby enabling the thumb and linkage assembly 150 to assume a more forward leaning position in FIG. 18 as compared to the more upright position illustrated in FIG. 4.

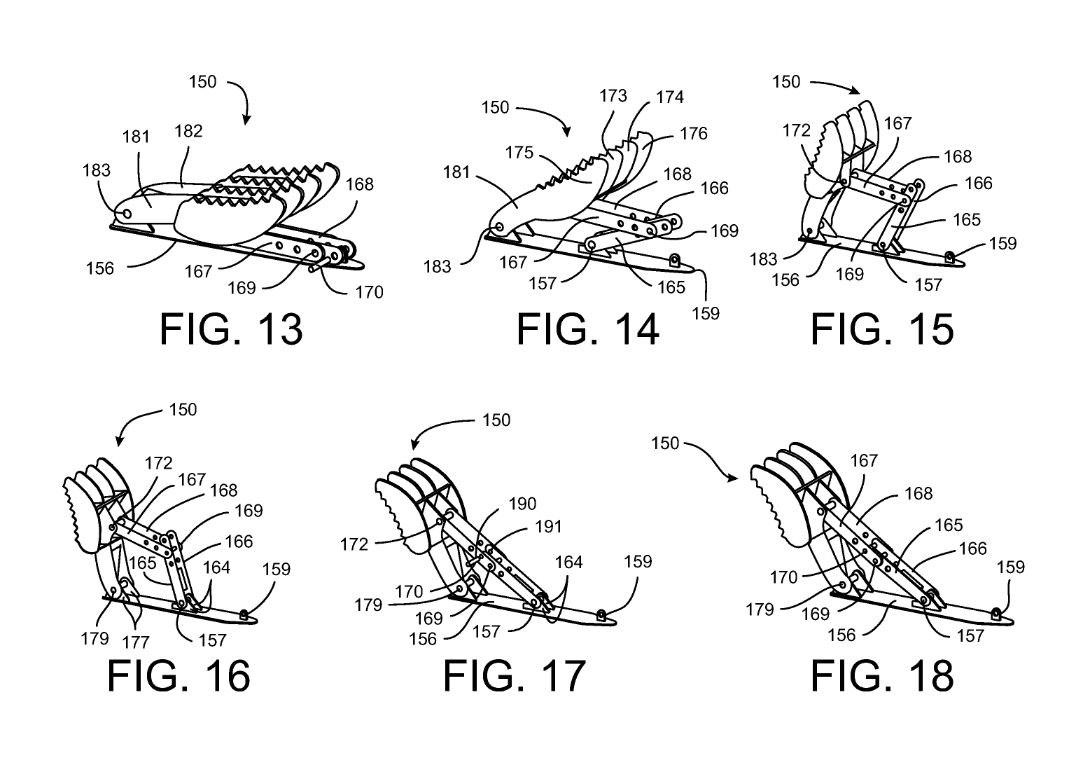

After the pivot adjustment is made in FIGS. 11-12, the removable pin 170 is removed as shown in FIG. 13 and the thumb and linkage assembly 150 may be lifted upward and over along the arcuate path illustrated in FIGS. 14-18. Once the maximum extension has been reached as shown in FIG. 17, the removable pin 170 is received in either of the holes 191 or 190 since the hole 192 is occupied by the removable pin 169. As shown in FIG. 18, the combination of the removable pin 170 and removable pin 169 converts the pairs of base links/thumb links 165, 167 and 166, 168 into straight struts as illustrated in FIG. 18.

### INDUSTRIAL APPLICABILITY

The disclosed thumb and linkage assemblies 150 are particularly suitable for excavators like that shown at 30 in FIG. 1 for purposes of enclosing an open bucket 41 as illustrated in FIG. 2. However, a problem as been alleviated by avoiding any disconnection between the thumbs 173-176 and the links 165, 167 or 166, 168. The maintained pivotal connections between the thumbs 173-176 and the thumb links 167, 168 by the pivot pin 172 and the maintained connection between the bracket 156 and the legs 181, 182 by way of the pivot pin 179, the four thumbs 173-176 of the thumb and linkage assembly 150 cannot swing freely thereby causing a safety hazard. Only one pin 170 needs to be removed to move the thumb and linkage assembly 150 from a stored position to a working position as shown in FIGS. 13-18. Further, in the embodiment illustrated in FIGS. 1-18, the overall length of the base link/thumb link pairs 165, 167 or 166, 168 may be changed by moving the removable pin 169 while maintaining the removable pin 170 in a locked position as illustrated in FIGS. 11-12.

What is claimed is:

1. A thumb and linkage assembly for an excavator having a lift arm, the thumb and linkage assembly comprising:
a bracket coupled to the lift arm;
a base link and a thumb link, the base link having a proximal portion pivotally coupled to the bracket, the base link also having a distal portion pivotally coupled to a proximal portion of the thumb link;
the thumb link having a distal portion pivotally coupled to at least one thumb of a plurality of thumbs, the plurality of thumbs being coupled together and pivotally coupled to the bracket;
the bracket including a first lock hole for locking the assembly in a stored position, at least one of the proximal portion of the thumb link, the distal portion of the base link or one of the thumbs including a second lock hole that is in axial alignment with the first lock hole when the assembly is in the stored position;
a removable pin that is received in the first and second lock holes for locking the assembly in the stored position.

2. The thumb and linkage assembly of claim 1 wherein base link and the thumb link each include at least one additional hole that are in axial alignment when the assembly has been moved to an extended position, the removable pin being received in additional holes for locking the assembly in the extended position.

3. The thumb and linkage assembly of claim 1 wherein the base link and the thumb link each include a plurality of additional holes and wherein the base link is pivotally coupled the thumb link by a pin, the pin may be placed in a variety of two aligned additional holes of the base and thumb links for adjusting a combined length of the base and thumb links and for adjusting the position of the thumbs in an extended position.

4. The thumb and linkage assembly of claim 1 wherein the thumbs are pivotally coupled to the bracket at a distal portion thereof and the first lock hole is disposed at a proximal portion of the bracket.

5. The thumb and linkage assembly of claim 1 wherein the proximal portion of the base link may be pivotally coupled to the bracket at a plurality of positions along the bracket.

6. The thumb and linkage assembly of claim 1 wherein the distal portion of the base link is pivotally connected to the thumb link by a pin that removably passes through a hole in the distal portion of the base link.

7. An excavator comprising:
a lift arm pivotally coupled to a bucket;
a thumb and linkage assembly pivotally coupled to the lift arm,
the thumb and linkage assembly including an elongated bracket having a proximal portion and a distal portion, the elongated bracket is coupled to the lift arm, the elongated bracket including an elongated base disposed between at least one pair of walls;
each wall including at least one hole that is axially aligned with a hole in the other wall to provide a first pair of axially aligned holes;
a pair of base links and a pair of thumb links, the base links each having a proximal portion pivotally coupled to the bracket at the first pair of axially aligned holes, the base links also each having a distal portion pivotally coupled to a proximal portion of one of the thumb links;
the thumb links each having a distal portion pivotally coupled to at least one thumb of a plurality of spaced-apart thumbs, the plurality of thumbs being coupled together and pivotally coupled to the distal portion of the bracket;
the proximal portion of the bracket including a first lock hole for locking the assembly in a stored position, at least one of proximal portions of the thumb links, the distal portions of the base links or one of the thumbs including a second lock hole that is in axial alignment with the first lock hole when the assembly is in the stored position;
a removable pin that is received in the first and second lock holes for locking the assembly in the stored position.

8. The excavator of claim 7 wherein at least one base link that is pivotally coupled to one of the thumb links and said one of the thumb links each including at least one additional hole that are in axial alignment when the assembly has been moved to an extended position, the removable pin being received in additional holes for locking the assembly in the extended position.

9. The excavator of claim 7 wherein each base link is pivotally coupled one of the thumb links by a removable pin to form two base link/thumb link couplings,
and wherein each base link and each thumb link include a plurality of additional holes and the removable pins may be placed in a variety of two aligned additional holes of a base link/thumb link coupling for adjusting a combined length of the base link/thumb link coupling and for adjusting the position thumbs in an extended position.

10. The excavator of claim 7 the thumbs are pivotally coupled to the bracket at a distal portion of the bracket and the first lock hole is disposed at a proximal portion of the bracket.

11. The excavator of claim 7 wherein the proximal portions of the base links may be pivotally coupled to the bracket at a plurality of positions along the bracket.

12. The excavator of claim 7 wherein the distal portions of each base link are pivotally connected to the proximal portions of each thumb link by a pin that passes through holes in the distal portions of the base links.

13. The excavator of claim 7 wherein the plurality of generally parallel thumbs includes about four thumbs including two inner thumbs disposed between two outer thumbs, the inner thumbs being pivotally connected to the bracket.

14. The excavator of claim 7 wherein the four thumbs are connected by two cross beams.

15. A method for securing a thumb and linkage assembly in a stored position against a lift arm of an excavator, the method comprising:
providing a thumb and linkage assembly that includes a bracket coupled to the lift arm, a base link and a thumb link, the base link having a proximal portion pivotally coupled to the bracket, the base link also having a distal portion pivotally coupled to a proximal portion of the thumb link, the distal portion of the base link and the proximal portion of the thumb link including an additional hole for receiving a removable pin when the base and thumb links are in alignment with each other, the thumb link having a distal portion pivotally coupled to at least one thumb of a plurality of thumbs, the plurality of thumbs being coupled together and pivotally coupled to the bracket, the bracket including a first lock hole for locking the assembly in a stored position, at least one of the proximal portion of the thumb link, the distal portion of the base link or one of the thumbs including a second lock hole that is in axial alignment with the first lock hole when the assembly is in the stored position, the pin that is received in the first and second lock holes for locking the assembly in the stored position;
removing the pin from the additional holes of the thumb and base links;
fold the thumbs towards the bracket and lift arm;
inserting the pin through the first and second lock holes.

16. The method of claim 15 further including disposing the second lock hole is along the proximal portion of the base link.

17. The method of claim 15 further including disposing the second lock hole along the distal portion of the thumb link.

18. The method of claim 15 further including disposed the second lock hole in one of the thumbs.

19. The method of claim 15 further including providing a pair of spaced apart base links pivotally connected to the bracket and a pair of spaced apart thumb links.

20. The method of claim 15 further including providing four parallel thumbs coupled together and including two middle thumbs, each of which is pivotally connected to one of the thumb links and the bracket.
